(19) United States
(12) Patent Application Publication
(10) Pub. No.: US 2026/0197105 A1
(43) Pub. Date: Jul. 9, 2026

(54) RADIO WAVE VISUALIZATION SYSTEM, THREE-DIMENSIONAL MODEL CREATION DEVICE, RADIO WAVE VISUALIZATION METHOD AND PROGRAM

(71) Applicant: NTT, Inc., Tokyo (JP)

(72) Inventors: Tomoki MURAKAMI, Musashino-shi, Tokyo (JP); Tomoaki OGAWA, Musashino-shi, Tokyo (JP); Masashi IWABUCHI, Musashino-shi, Tokyo (JP); Riku OMIYA, Musashino-shi, Tokyo (JP); Ryotaro TANIGUCHI, Musashino-shi, Tokyo (JP)

(21) Appl. No.: 19/125,844

(22) PCT Filed: Nov. 2, 2022
(86) PCT No.: PCT/JP2022/041054

§ 371 Date: Apr. 30, 2025

(51) Int. Cl. H04B 17/391

(52) U.S. Cl. CPC H04B 17/3912

(57) ABSTRACT

A radio wave visualization system according to an embodiment includes: a model creation unit that creates a three-dimensional scale model of an environment including a terrain and a building of an area to be evaluated for a propagation characteristic of radio waves used for a wireless communication system in which a base station and a terminal station perform wireless communication via a RIS reflector; an evaluation condition creation unit that creates a plurality of evaluation conditions used for evaluating the propagation characteristic of radio waves for the target area on the basis of performance of the wireless communication system; and a RIS simulation unit that simulates and adds a reflection characteristic of the RIS reflector to the three-dimensional scale model created by the model creation unit on the basis of each of the plurality of evaluation conditions created by the evaluation condition creation unit.

### TECHNICAL FIELD

The present invention relates to a radio wave visualization system, a three-dimensional model creation device, a radio wave visualization method, and a program.

### BACKGROUND ART

In recent years, introduction of new wireless communication systems represented by 5th generation mobile communication system (5G) and local 5G has been explosively increased. In a case where those wireless communication systems are installed, evaluation utilizing radio wave propagation simulation is essential. In order to efficiently evaluate radio wave propagation, there has been studied a technique of visualizing a result of radio wave propagation simulation to optimize settings of the wireless communication system.

For example, in a case where radio wave propagation is visualized, a propagation simulation is performed by creating a three-dimensional environment model for an environment in which the wireless communication system is installed and setting basic performances of the wireless communication system (center frequency, frequency band, transmission power, antenna condition, and installation position) and evaluation conditions necessary for the propagation simulation (e.g. number of reflections, number of diffractions, and transmission/reflection conditions) (see, for example, Non Patent Literature 1).

The radio wave propagation simulation and visualization are desirably performed before the wireless communication system is installed. In a case where the wireless communication system is installed in an actual environment, a requirement condition may be different depending on a change in environment or for each communication area. Therefore, a system that can evaluate radio wave propagation characteristics in real time is required.

Further, in recent years, research and development of a device that can change a reflection direction in which radio waves are propagated and a gain, which is called a reconfigurable intelligence surface (RIS), has been advanced, and evaluation of a communication area including the RIS has also been expected.

### CITATION LIST

### Non Patent Literature

Non Patent Literature 1: Tetsuro Imai, “Mobile Radio Propagation Simulation Based on Ray-Tracing Method”, The Institute of Electronics, Information and Communication Engineers, 2009, IEICE Transactions B Vol. J 92-B No. 9, pp.1333-1347

### SUMMARY OF INVENTION

### Technical Problem

However, in order to visualize radio wave propagation in real time, real-time operation of each step for performing a propagation simulation is essential. In particular, it is known that calculation in the propagation simulation is a bottleneck. Further, in a case where a radio wave propagation simulation is performed by strictly inputting characteristics of the RIS, more evaluation conditions are required, which increases a calculation load of the propagation simulation.

The present invention has been made in view of the above problems, and an object thereof is to provide a radio wave visualization system, a three-dimensional model creation device, a radio wave visualization method, and a program capable of easily visualizing a propagation characteristic of radio waves of a wireless communication system that performs wireless communication via a RIS reflector without using the RIS reflector.

### Solution to Problem

A radio wave visualization system according to an embodiment of the present invention includes: a model creation unit that creates a three-dimensional scale model of an environment including a terrain and a building of an area to be evaluated for a propagation characteristic of radio waves used for a wireless communication system in which a base station and a terminal station perform wireless communication via a RIS reflector; an evaluation condition creation unit that creates a plurality of evaluation conditions used for evaluating the propagation characteristic of radio waves for the area on the basis of performance of the wireless communication system; a RIS simulation unit that simulates and adds a reflection characteristic of the RIS reflector to the three-dimensional scale model created by the model creation unit on the basis of each of the plurality of evaluation conditions created by the evaluation condition creation unit; a propagation simulator that simulates a plurality of the propagation characteristics for the three-dimensional scale model in which the RIS simulation unit has simulated the reflection characteristic of the RIS reflector by using the plurality of evaluation conditions created by the evaluation condition creation unit and outputs simulation results; and a visualization unit that sequentially visualizes the simulation results of the plurality of propagation characteristics output by the propagation simulator.

A three-dimensional model creation device according to an embodiment of the present invention includes: a model creation unit that creates a three-dimensional scale model of an environment including a terrain and a building of an area to be evaluated for a propagation characteristic of radio waves used for a wireless communication system in which a base station and a terminal station perform wireless communication via a RIS reflector; an evaluation condition creation unit that creates a plurality of evaluation conditions used for evaluating the propagation characteristic of radio waves for the area on the basis of performance of the wireless communication system; and a RIS simulation unit that simulates and adds a reflection characteristic of the RIS reflector to the three-dimensional scale model created by the model creation unit on the basis of each of the plurality of evaluation conditions created by the evaluation condition creation unit.

A radio wave visualization method according to an embodiment of the present invention includes: a model creation step of creating a three-dimensional scale model of an environment including a terrain and a building of an area to be evaluated for a propagation characteristic of radio waves used for a wireless communication system in which a base station and a terminal station perform wireless communication via a RIS reflector; an evaluation condition creation step of creating a plurality of evaluation conditions used for evaluating the propagation characteristic of radio waves for the area on the basis of performance of the wireless communication system; a RIS simulation step of simulating and adding a reflection characteristic of the RIS reflector to the three-dimensional scale model created in the model creation step on the basis of each of the plurality of evaluation conditions created in the evaluation condition creation step; a propagation simulation step of simulating a plurality of the propagation characteristics for the three-dimensional scale model in which the reflection characteristic of the RIS reflector has been simulated in the RIS simulation step by using the plurality of evaluation conditions created in the evaluation condition creation step and outputting simulation results; and a visualization step of sequentially visualizing the simulation results of the plurality of propagation characteristics output in the propagation simulation step.

### Advantageous Effects of Invention

According to the present invention, it is possible to easily visualize a propagation characteristic of radio waves of a wireless communication system that performs wireless communication via a RIS reflector without using the RIS reflector.

### BRIEF DESCRIPTION OF DRAWINGS

FIG. 1 schematically shows an overview of a configuration of a radio wave visualization system according to an embodiment.

FIG. 2 shows an example of a radio wave visualization method of visualizing radio waves by the radio wave visualization system.

FIG. 3 shows a hardware configuration example of a three-dimensional model creation device.

### DESCRIPTION OF EMBODIMENTS

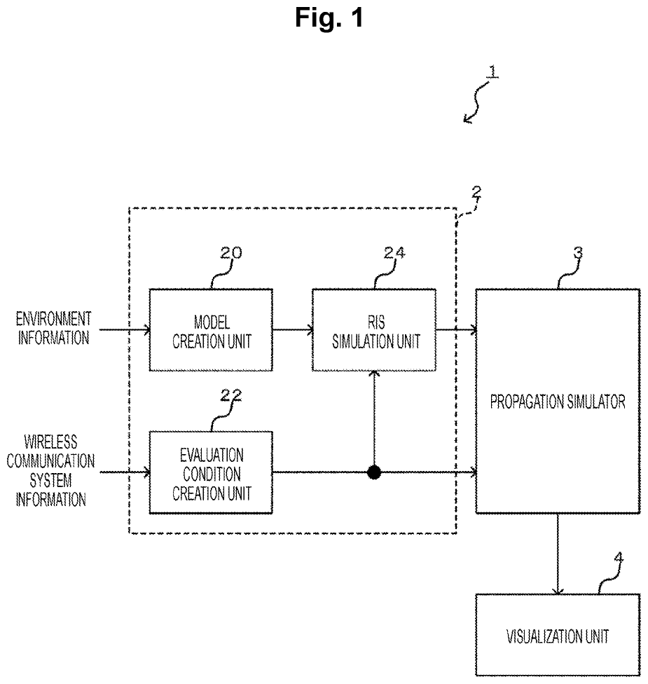

Hereinafter, a radio wave visualization system according to an embodiment will be described with reference to the drawings. FIG. 1 schematically shows an overview of a configuration of a radio wave visualization system 1 according to an embodiment.

As shown in FIG. 1, the radio wave visualization system 1 includes, for example, a three-dimensional model creation device 2, a propagation simulator 3, and a visualization unit 4. The radio wave visualization system 1 simulates and visualizes radio wave propagation in an environment including a terrain and a building of an area (target area) where, for example, a wireless communication system in which one or more base stations and one or more terminal stations perform wireless communication is scheduled to be installed.

The environment of the target area includes a reflector or a relay station that reflects or relays radio waves emitted by the base station or the terminal station.

The three-dimensional model creation device 2 includes a model creation unit 20, an evaluation condition creation unit 22, and a RIS simulation unit 24.

The model creation unit 20 acquires environment information indicating the environment of the target area and creates a scale model for reproducing the environment of the target area. For example, the model creation unit 20 creates a reduced three-dimensional scale model by using, for example, a three-dimensional (3D) printer from a predetermined material, the three-dimensional scale model reproducing an environment including a terrain and a building of an area to be evaluated for a propagation characteristic of radio waves used for the wireless communication system in which the base station and the terminal station perform wireless communication via an RIS reflector.

The evaluation condition creation unit 22 creates a plurality of evaluation conditions used for evaluating the propagation characteristic of radio waves for the target area on the basis of wireless communication system information indicating performance of the wireless communication system and outputs the evaluation conditions to the RIS simulation unit 24 and the propagation simulator 3.

For example, the evaluation condition creation unit 22 creates evaluation conditions that reflect reflection characteristics in which an actual RIS reflector reflects radio waves incident at a predetermined incident angle. For example, the evaluation conditions include a reflection direction dynamically controlled by the RIS reflector, an action of collecting radio waves to a specific point by the RIS reflector, and scattering of radio waves by the RIS reflector.

The RIS simulation unit 24 simulates and adds the reflection characteristics of the RIS reflector to the three-dimensional scale model created by the model creation unit 20 on the basis of the plurality of evaluation conditions created by the evaluation condition creation unit 22.

For example, the RIS simulation unit 24 adjustably simulates and adds the reflection characteristics of the actual RIS reflector (reflection direction, gain, and beam width) by making at least one of the number, size, dielectric constant, and shape of reflectors that simulate the actual RIS reflector variable.

The propagation simulator 3 simulates a plurality of propagation characteristics for the three-dimensional scale model in which the RIS simulation unit 24 has simulated the reflection characteristics of the RIS reflector by using the plurality of evaluation conditions created by the evaluation condition creation unit 22 and outputs simulation results to the visualization unit 4.

The visualization unit 4 is, for example, a display (display device) and sequentially visualizes the simulation results of the plurality of propagation characteristics output by the propagation simulator 3. The visualization unit 4 may be configured to visualize only direct waves.

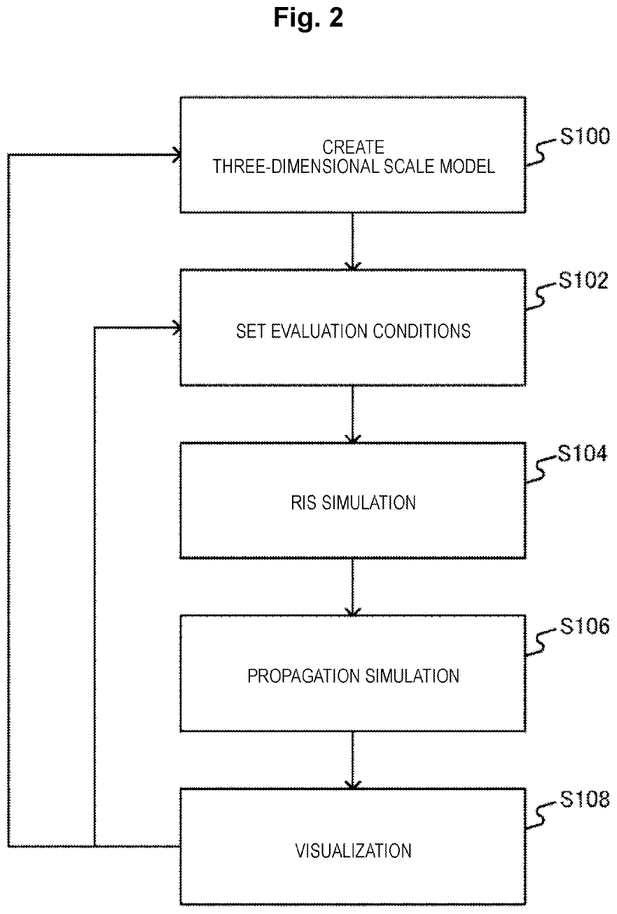

Next, an example of a radio wave visualization method of visualizing radio waves by the radio wave visualization system 1 will be described. FIG. 2 shows an example of the radio wave visualization method of visualizing radio waves by the radio wave visualization system 1.

As shown in FIG. 2, in order to visualize radio waves, the model creation unit 20 of the radio wave visualization system 1 first creates a three-dimensional scale model (S100). Next, the radio wave visualization system 1 sets evaluation conditions created by the evaluation condition creation unit 22 to the RIS simulation unit 24 and the propagation simulator 3 (S102).

Next, the RIS simulation unit 24 simulates and adds (RIS simulation) reflection characteristics of the RIS reflector to the three-dimensional scale model created by the model creation unit 20 on the basis of the plurality of evaluation conditions created by the evaluation condition creation unit 22 (S104).

The propagation simulator 3 simulates a plurality of propagation characteristics for the three-dimensional scale model in which the RIS simulation unit 24 has simulated and added the reflection characteristics of the RIS reflector by using the plurality of evaluation conditions created by the evaluation condition creation unit 22 and outputs simulation results to the visualization unit 4 (S106).

Then, the visualization unit 4 sequentially visualizes the simulation results of the plurality of propagation characteristics output by the propagation simulator 3 (S108).

Then, the radio wave visualization system 1 returns to the processing in S102 if it is necessary to change the evaluation conditions due to a change in a target environment or the like and returns to the processing in S100 if it is necessary to create a three-dimensional scale model again.

As described above, in the radio wave visualization system 1, the RIS simulation unit 24 simulates and adds the reflection characteristics of the RIS reflector to the three-dimensional scale model created by the model creation unit 20 on the basis of the plurality of evaluation conditions created by the evaluation condition creation unit 22. This makes it possible to easily visualize the propagation characteristics of radio waves of the wireless communication system that performs wireless communication via a RIS reflector without using the RIS reflector.

Note that some or all of each unit included in the radio wave visualization system 1 may be configured by hardware such as a programmable logic device (PLD) or a field programmable gate array (FPGA) or may be configured as a program executed by a processor such as a CPU.

For example, each unit included in the radio wave visualization system 1 can be implemented by using a computer and a program, and the program can be recorded in a storage medium or provided through a network.

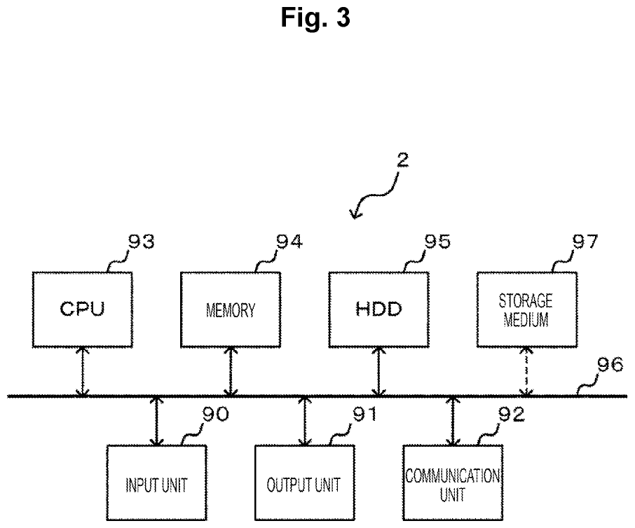

FIG. 3 shows a hardware configuration example of the three-dimensional model creation device 2. As shown in FIG. 3, for example, the three-dimensional model creation device 2 is such that an input unit 90, an output unit 91, a communication unit 92, a CPU 93, a memory 94, and an HDD 95 are connected via a bus 96 and has functions of a computer. The three-dimensional model creation device 2 can input and output data to and from a computer-readable storage medium 97.

The input unit 90 is, for example, a keyboard and a mouse. The output unit 91 is, for example, a display device such as a display. The communication unit 92 is, for example, a network interface.

The CPU 93 controls each unit included in the three-dimensional model creation device 2 and performs predetermined processing and the like. The memory 94 and the HDD 95 are storage units that store data and the like.

The storage medium 97 can store a program or the like for executing the functions of the three-dimensional model creation device 2. Note that the architecture constituting the three-dimensional model creation device 2 is not limited to the example of FIG. 3.

### REFERENCE SIGNS LIST

1 Radio wave visualization system
2 Three-dimensional model creation device
3 Propagation simulator
4 Visualization unit
20 Model creation unit
22 Evaluation condition creation unit
24 RIS simulation unit
90 Input unit
91 Output unit
92 Communication unit
93 CPU
94 Memory
95 HDD
96 Bus
97 Storage medium

1. 1. A radio wave visualization system comprising:
model creation circuitry configured to create a three-dimensional scale model of an environment including a terrain and a building of an area to be evaluated for a propagation characteristic of radio waves used for a wireless communication system in which a base station and a terminal station perform wireless communication via a RIS reflector;
evaluation condition creation circuitry configured to create a plurality of evaluation conditions used for evaluating the propagation characteristic of radio waves for the area on the basis of performance of the wireless communication system;
RIS simulation circuitry configured to simulate and add a reflection characteristic of the RIS reflector to the three-dimensional scale model created by the model creation circuitry on the basis of each of the plurality of evaluation conditions created by the evaluation condition creation circuitry;
a propagation simulator that simulates a plurality of the propagation characteristics for the three-dimensional scale model in which the RIS simulation circuitry has simulated the reflection characteristic of the RIS reflector by using the plurality of evaluation conditions created by the evaluation condition creation circuitry and outputs simulation results; and
visualization circuitry configured to sequentially visualize the simulation results of the plurality of propagation characteristics output by the propagation simulator.

2. The radio wave visualization system according to claim 1, wherein
the RIS simulation circuitry
simulate and add the reflection characteristic of the RIS reflector by making at least one of the number, size, dielectric constant, or shape of reflectors that simulate the RIS reflector variable.

3. A three-dimensional model creation device comprising:
model creation circuitry configured to create a three-dimensional scale model of an environment including a terrain and a building of an area to be evaluated for a propagation characteristic of radio waves used for a wireless communication system in which a base station and a terminal station perform wireless communication via a RIS reflector;
evaluation condition creation circuitry configured to create a plurality of evaluation conditions used for evaluating the propagation characteristic of radio waves for the area on the basis of performance of the wireless communication system; and
RIS simulation circuitry configured to simulate and add a reflection characteristic of the RIS reflector to the three-dimensional scale model created by the model creation circuitry on the basis of each of the plurality of evaluation conditions created by the evaluation condition creation circuitry.

4. The three-dimensional model creation device according to claim 3, wherein
the RIS simulation circuitry
simulate and add the reflection characteristic of the RIS reflector by making at least one of the number, size, dielectric constant, or shape of reflectors that simulate the RIS reflector variable.

5. A radio wave visualization method comprising:
creating a three-dimensional scale model of an environment including a terrain and a building of an area to be evaluated for a propagation characteristic of radio waves used for a wireless communication system in which a base station and a terminal station perform wireless communication via a RIS reflector;
creating a plurality of evaluation conditions used for evaluating the propagation characteristic of radio waves for the area on the basis of performance of the wireless communication system;
simulation step of simulating and adding a reflection characteristic of the RIS reflector to the three-dimensional scale model created in model creating on the basis of each of the plurality of evaluation conditions created in evaluation condition creating;
simulating a plurality of the propagation characteristics for the three-dimensional scale model in which the reflection characteristic of the RIS reflector has been simulated in RIS simulation by using the plurality of evaluation conditions created in evaluation condition creating and outputting simulation results; and
sequentially visualizing the simulation results of the plurality of propagation characteristics output in propagation simulation.

6. The radio wave visualization method according to claim 5, wherein
in RIS simulating,
the reflection characteristic of the RIS reflector is simulated and added by making at least one of the number, size, dielectric constant, or shape of reflectors that simulate the RIS reflector variable.

7. A non-transitory computer-readable storage medium storing a program for causing a computer to function as each circuitry of the three-dimensional model creation device according to claim 3.
